(19) United States
(12) Patent Application Publication
(10) Pub. No.: US 2022/0322614 A1
(43) Pub. Date: Oct. 13, 2022

(54) FLEXIBLE SEEDLING TRAY WITH CARRIER TAB

(71) Applicant: RYAN THOMAS SAUCHELLI, GAINESVILLE, FL (US)

(72) Inventor: RYAN THOMAS SAUCHELLI, GAINESVILLE, FL (US)

(21) Appl. No.: 17/717,232

(22) Filed: Apr. 11, 2022

Related U.S. Application Data
(60) Provisional application No. 63/201,086, filed on Apr. 12, 2021.

(51) Int. Cl. A01G 9/029

(52) U.S. Cl. CPC A01G 9/0295; A01G 9/0299

(57) ABSTRACT

A flexible seedling tray with at least one carrier tab for lifting the seedling tray. The seedling tray has a plurality of upwardly tapered cells arranged in rows and columns. The cells can be connected or joined together across an upper terminus to which is attached the at least one carrier tab. When the seedling tray is lifted by the at least one carrier tab, the flexibility of the seedling tray and the taper of the cells causes the cells to come together, bringing the base surfaces together to form a stable arc across the bottom side. The force of the cells pressing against each other provides support and rigidity to the seedling tray for easier transport. When placed on a surface, the cells separate and are supported on the surface.

### CROSS REFERENCE TO RELATED APPLICATION

The present application claims the benefit of U.S. Provisional Application No. 63/201,086, filed Apr. 12, 2021.

### FIELD OF THE INVENTION

The present disclosure broadly concerns seedling trays. More particularly, the present disclosure relates to flexible seedling trays with carrying handles.

### BACKGROUND

Growing plants and vegetables often requires the use of seedling trays. Seedling trays typically contain a plurality of cells that are filled with a planting medium such as soil, or they are used hydroponically. Seedling trays are commonly used to initiate the germination of seeds and growth of young plants. Seedlings are frequently started in controlled-climate environments and are later transplanted into the ground for final growth.

Seedlings are grown in individual cells of a seedling tray and removed from the seedling tray prior to planting. To facilitate removal, seedling trays are often made of a flexible or bendable material that allows the cells to be squeezed or pushed upwards from the bottom end to extract the seedlings from the cells. A seedling tray is usually moved to the planting area where seedlings are removed from the individual cells. The flexibility that allows removal of the seedlings can be prohibitive for larger seedling trays, which can make them difficult to transport if not properly supported from below.

There is a need for a flexible seedling tray that allows seedlings to be easily removed and that can be held and transported easily in a stable way. It would also be desirable for seedling tray to be larger and support a wide range of weights and quantities of seedling cells, while still being easy to transport.

### SUMMARY

Embodiments of the subject invention pertain to a seedling tray. More particularly, embodiments of the subject invention pertain to a flexible seedling tray with at least one carrier tab to facilitate transport. The carrier tab can provide several advantages for the flexible seedling tray. First, the carrier tab provides a stable method for transporting seedling trays of various sizes and weights. Second, the novel seedling tray provides an ergonomic solution to the unwieldiness of flexible seedling trays by allowing the cells to collapse or fall against and support each other when being carried. This provides the third advantage to the flexible seedling tray of the subject invention by allowing a multitude of options for sizes and weight capacities, providing a variety of possibilities in both commercial and non-commercial applications.

In one embodiment, the seedling tray has a plurality of cells arranged in rows with at least one carrier tab between the rows. The diameter of the cells can be larger at a top end or upper edge than at the bottom end or base surface, such that the cells are tapered and there is an aperture or space between the cells. When the flexible seedling tray is raised or carried by the carrier tab, the aperture allows the narrower base surfaces to come together bringing at least a portion of the side walls of the cells together so as to provide support and stability to the seedling tray.

Additional embodiments can include multiple carrier tabs by which the seedling tray can be held and transported and a flood rim around the outside or periphery of the upper end of the cells.

### BRIEF DESCRIPTION OF THE DRAWINGS

In order that a more precise understanding of the above recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description are specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 is a perspective view of a flexible seedling tray according to one embodiment of the present invention.

FIG. 2 is a front view of FIG. 1.

FIG. 3 is a top view of FIG. 1.

FIG. 4 is a bottom view of FIG. 1.

FIG. 5 is a side view of FIG. 1.

FIG. 6 illustrates one use of the present invention. As shown, the cells of the seed tray come together when the seedling tray is raised or carried by the carrier tab, which lends support and stability to the cells and the seedling tray.

FIG. 7 is a perspective view of a flexible seedling tray according to an alternative embodiment of the present invention. With this embodiment, at least a portion of the side walls of the cells are shared or joined between two or more cells.

FIG. 8 is a perspective view of a flexible seedling tray according to an alternative embodiment of the present invention. In this embodiment, there is a single row of cells and at least a portion of the side walls of the cells are shared or joined between two cells.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and the order in which the drawings is described should not be perceived as order of significance.

As used herein, terms indicating relative direction or orientation, including but not limited to “upper”, “lower”, “top”, “bottom”, “vertical”, “horizontal”, “outer”, “inner”, “front”, “back”, “side” and the like, are intended to facilitate description of the present invention by indicating relative orientation or direction in usual use, and are not intended to limit the scope of the present invention in any way to such orientations or directions.

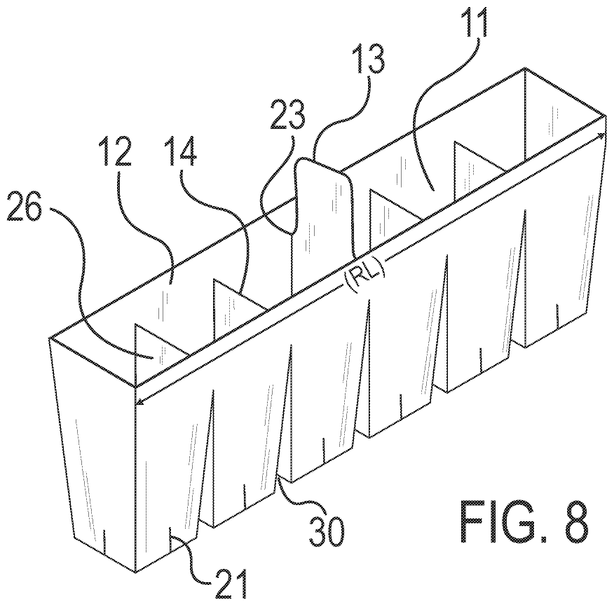

The present invention relates generally to a flexible seedling tray 10 for germinating and propagating seeds. One embodiment of the flexible seedling tray 10 has a plurality of tapered cells 11 arranged in a “row and column” formation, where the cells can be integrally connected or joined to one another along an upper portion of the side walls 17, so that they have a shared sidewall, such as shown, for example, in FIGS. 7 and 8.

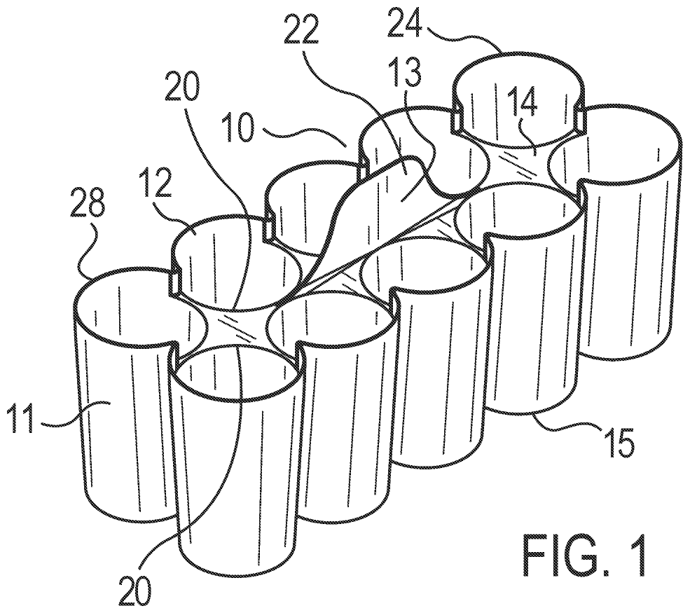

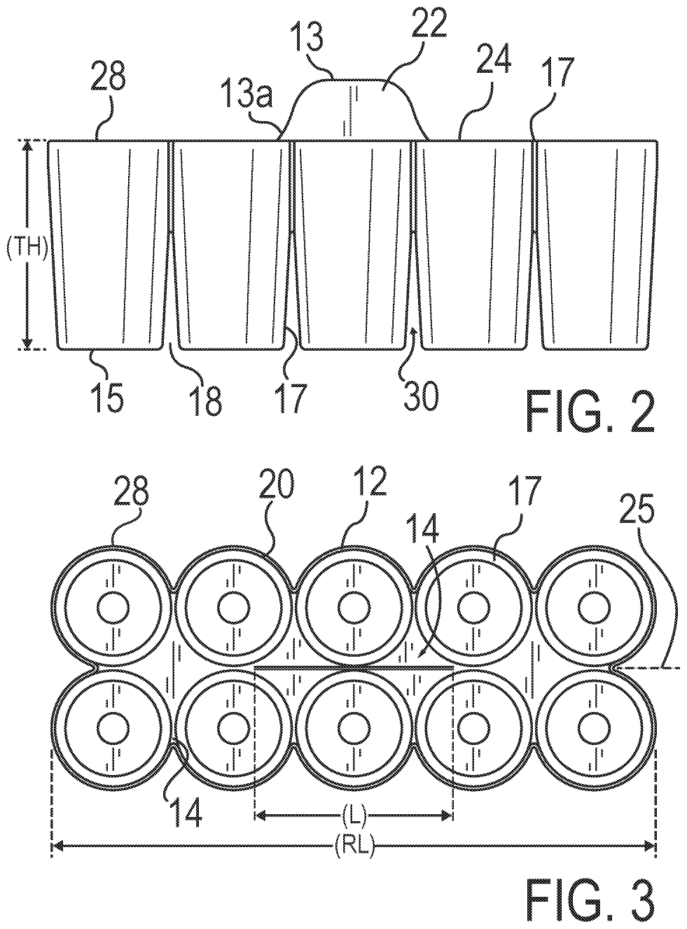

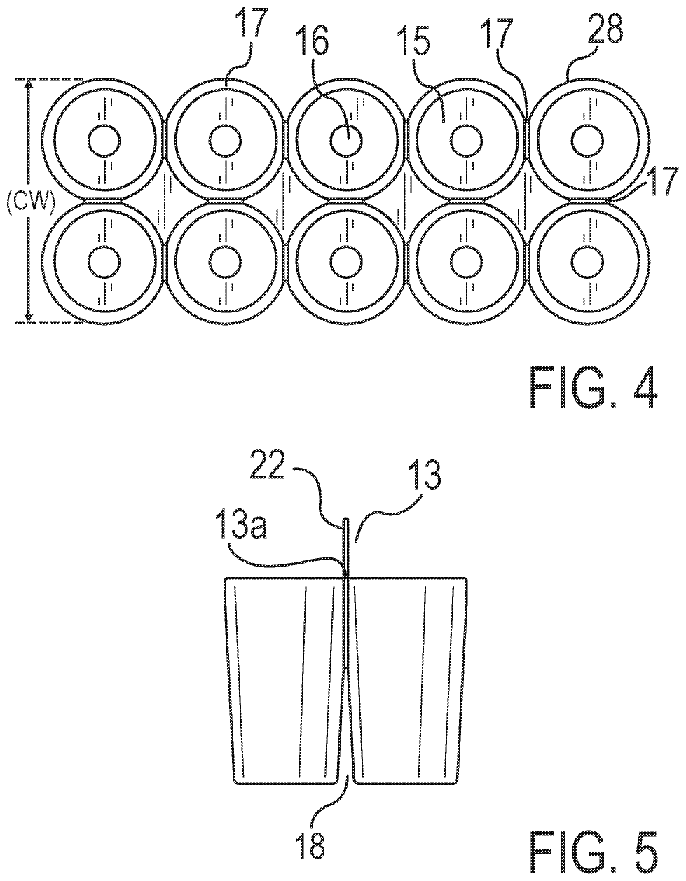

In an alternative embodiment, the cells are joined by an upper terminus 14 arranged between at least some portion of the cells, such as shown, for example, in FIGS. 1 and 3. In one embodiment, the upper terminus forms a continuous surface between at least a portion of the cells at or near the upper edges 20. The cells can extend or protrude downwardly from the upper terminus 14 and the base surfaces 15 can terminate in a common lower plane, as shown, for example, in FIGS. 1 and 2. The taper of the cells can also provide an aperture 18 between the cells at or near the base surfaces 15.

In a further embodiment, illustrated in FIG. 1, there is a flood rim 12 that extends upwardly from the outside of the upper edges and the upper terminus 14 between the cells and that can terminate on a common upper plane 24. In one embodiment, the flood rim extends around the periphery 28 of the seedling tray to enclose the cells around the upper edges 20 of the cells, as shown, for example, in FIGS. 1 and 3. In a particular embodiment, the flood rim is continuous with the upper terminus 14 between the cells, one example of which is shown in FIGS. 1 and 3.

Extending upwardly from and integrally attached to the upper terminus 14 is at least one carrier tab 13. In one embodiment, the at least one carrier tab is arranged at or near an upper terminus center line 25 and between two rows of cells, one example of which is shown in FIG. 3. The carrier tab can have a base 13a, as seen in FIG. 2, that is flared outwardly along the center line, where it meets the upper terminus. The upper or carrier tab end 22 above the base of the carrier tab can have any of a variety of shapes, contours, decorative features, or ergonomic configurations.

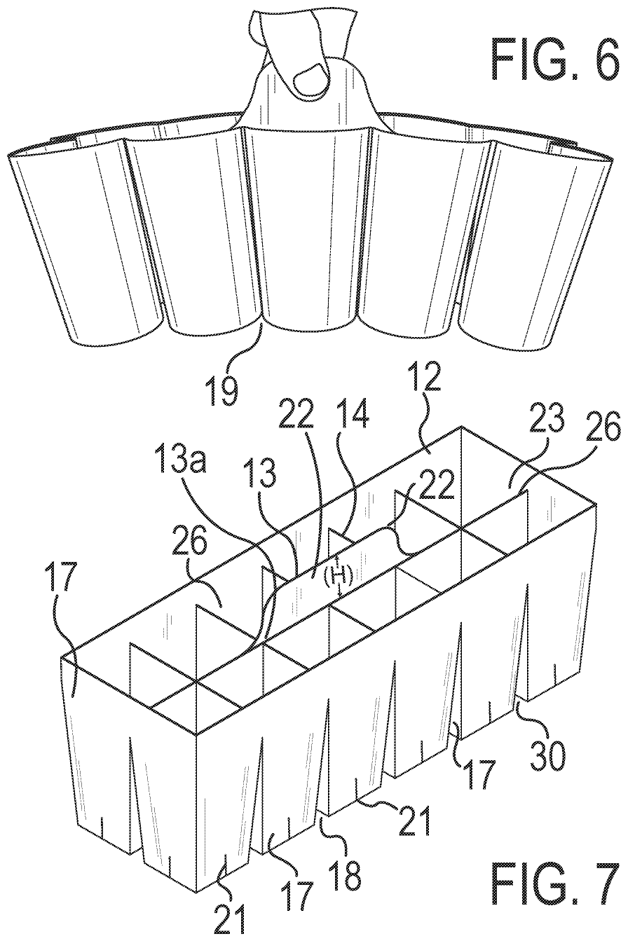

The at least one carrier tab 13 can be useful as a handle to pick up and carry the seedling tray with minimal impact to seedlings within the cells 11. As depicted in FIG. 6, a carrier tab can be gripped and used to lift up or raise the seedling tray from a surface. The taper of the cells creates spaces or apertures 18 between the cells and the flexibility of at least the upper terminus 14 can allow the cells to contract, fold, or otherwise move inward and against each other so that an arc 19 is formed by the base surfaces, as depicted in FIG. 6. When lifted, the cells suspend from the carrier tab and the base surfaces come together and form a stable arc as illustrated in FIG. 6. Once the seedling tray is returned to a flat surface, the cells separate, the arc will flatten, the apertures 18 will re-expand, and the seedling tray can return to the original shape and configuration.

The at least one carrier tab can allow the flexible seedling tray to be transported conveniently with one or two hands with ease. The advantageous placement of the one or more carrier tabs along the center line 25 on the seedling tray allows for the weight to be suspended from the center line of the seedling tray. While a configuration with more than one carrier tab is not shown in the Figures, a configuration with more than one carrier tab and the use thereof would be understood by a person of skill in the art. This configuration can also allow the cells 11 to collapse or fold laterally otherwise come together or towards one another, when the seedling tray is lifted by one or more carrier tabs, keeping the seedling tray structurally stable. The arc 19 of the seedling tray base surfaces, when lifted, can be determined by the angle of the apertures 18 between adjoined tapered cells. Thus, the taper of the cells determines the size of the apertures, which can dictate the arc of the seedling tray when lifted by the one or more carrier tabs.

The carrier tab allows for larger and heavier loads to be lifted in a sturdy fashion. Typically, gardening soil or soil substitute is placed in each cell. When watered, the soil becomes heavier as it becomes more saturated and increases significantly in weight. The carrier tab 13 can be sued to support heavy loads, easily supporting seedling trays with large or multiple and numerous seedling cells. In a particular embodiment, the carrier tab has a textured surface or grip that provides friction, which can improve the handling of the seedling tray 10. In a further embodiment, the carrier tab is made from flexible, durable material, such as, for example, silicone, rubber, low density polyethylene, nylon, other plastics, and similarly flexible materials, and combinations thereof. In another embodiment, the carrier tab 13 can be folded down to allow seedling trays 10 to be stacked vertically.

In the embodiment illustrated in FIG. 1, FIG. 2 and FIG. 6, the carrier tab base 13a flares outwardly and is integral with or connected to the upper terminus 14. Advantageously, the carrier tab flared base 13a can inhibit ripping, tearing, or other separations or failings at the junction between carrier tab 13 and upper terminus 14. The shape, angle, length, and other dimensions of the base 13a flare can depend upon a variety of factors including, but not limited to, the one or more materials utilized for the seedling tray, the number of cells to be supported, the size of the cells, and other factors known to those with skill in the art.

Where the cells 11 of a seedling tray are joined at or about the upper edges 20 can define the upper terminus. In one embodiment illustrated in FIG. 1, the upper terminus 14 is a flat panel surface between the cells that aids in joining together the cells 11 and is also the point of connection between carrier tab and seedling tray. In another embodiment depicted in FIG. 7, the upper terminus 14 is defined by the shared side walls 26 or shared borders between cells. As shown in FIG. 7, the cells can be joined together or the cells can have a shared portion of a side wall 26 above the aperture 18. In FIG. 7, the carrier tab is shown attached to a center spine 23 where side walls are shared to form an upper terminus 14. The carrier tab or carrier tabs can be arranged along the center line 25 of the center spine.

For longer trays or for trays with large, heavy cells, a seedling tray 11 can have a plurality of carrier tabs 13 spaced evenly from each other along the row length (RL) on the upper terminus 14 center line 25. In one embodiment, the plurality of carrier tabs are arranged at equal distances from each other along the center line. A plurality of carrier tabs can assist in the suspension of a longer seedling tray by providing carrier tabs for carrying with both hands.

Carrier tabs 13 can vary in size, including height (H) and length (L). In one embodiment, the length (L) of a carrier tab, which is indicated in FIG. 3 as the distance between the ends of the flared base 13a. Embodiments of a carrier tab can have a length (L) that is at least 10%, 15%, 20%, 25%, 30%, 35%, and/or 40% of a total row length (RL) or a length (L) between any two of the listed values. The height (H) of a carrier tab can range between approximately 1″ and approximately 5″, between approximately 2″ and approximately 4″, and between approximately 2.5″ and approximately 3″. As young plants grow vertically from the cells 11, they can potentially crowd the carrier tab 13. Carrier tabs that are taller than the predetermined size of the plants surrounding can be easier to find and grip with minimal disruption to surrounding delicate plants. A carrier tab 13 can have any of a variety of shapes, including rectangles, ellipses, circles, semi-circles, triangles and various polygonal shapes, such as stars, cartoon characters, and other specialized shapes, or any combination thereof. By way of non-limiting example, a carrier tab can have a shape that can appeal to younger gardeners.

As depicted in FIG. 2, the seedling tray is comprised of multiple cells 11 that are tapered. Tapering the cells allows for easier removal of plants from the cells. The taper angle 30 between cells can be at least 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24° and/or 25° or angle between any two of the listed values. The embodiment shown in FIG. 2 shows an example of an approximately 6° taper.

FIG. 1 shows cells 11 that have a round circumferential shape. In other embodiments, cells are rectangular in shape with rounded corners or without rounded corners, as illustrated in FIG. 7. The circumferential shape of cells can vary depending on factors understood by those with skill in the art. Ideally, the circumferential shape and dimensions allow for a taper angle that provides the most advantageous arc 19 when the seedling tray is lifted by the carrier tab 13.

Embodiments of a seedling tray 10 have a uniform thickness ranging from between about 0.5 mm to about 2.0 mm. For smaller seedling trays, a smaller thickness of material can be acceptable. For larger seedling trays, a greater thickness of material can be preferred.

The dimensions of a cell 11 of a seedling tray 10, of the subject invention, can vary depending on the plants intended to be grown, the specific growing practices, and other factors mentioned above. In one particular embodiment, the dimensions of a cell 11 of a seedling tray 10 measure between approximately 2″ in diameter and approximately 3″ in height. In other embodiments, a cell 11 measures between approximately 1″ and approximately 4″ in diameter and between approximately 1.5″ and approximately 7″ in height.

The embodiment illustrated in FIG. 1 has ten cells arranged in two rows of five cells. An alternative embodiment can consist of a single row of cells with carrier tab 13 perpendicular to the center line 25 rather than parallel with the center line. Stated another way, a carrier tab can be arranged between two of the cells in the single row of cells, for example in the center of the single row of cells. A non-limiting example of this embodiment is shown in FIG. 8. There are numerous other variations possible with regard to the number of rows and columns per seedling tray 10. A person of skill in the art will understand that the total quantity of cells can depend on the size of each individual cell, which is typically identical in size to other cells in a seedling tray. Seedling trays with smaller cells can have more rows and columns than a seedling tray with larger cells.

The dimensions of a seedling tray can vary depending on the number of rows and columns of cells. In one embodiment, the number of cells in a row is greater than the number of cells in a column. In other words, a seedling tray can have a row length (RL) that is greater than a column width (CW). A seedling tray can have a row length (RL) between about 5″ and about 20″, more preferably between about 7″ and about 15″, and most preferably about 10″. A seedling tray can also have a column width (CW) that is between about 1.5″ and about 10″, between about 3″ and about 8″, and between about 4″ and about 5″. In one embodiment, the flood rim height is about 10%, about 15%, about 20%, about 25%, and/or about 30% of the total height of a cell or a height between any two of the listed values. The quantity of cells 11 and overall size and dimensions of seedling tray embodiments can be determined by a person of skill in the art depending on a variety of factors, including, but not limited to, the types of seeds intended to be planted, how long propagation will last, whether the seed tray is intended for large- or small-scale operations, and specific user preferences.

In one embodiment, each cell can have at least one drainage hole 16. Certain embodiments have a plurality of drainage holes depending on the size and shape of the cell. Larger cells can require more drainage. In one embodiment, a cell has a single drainage hole. In an alternative embodiment, a cell has a plurality of smaller drainage holes. Drainage hole 16 can be located on or through the base surfaces 15 of a cell. In alternative embodiments, one or more drainage slits 21 are located on a side wall 17 of a cell as illustrated in FIG. 7. Drainage holes and drainage slits can vary in sizes and shapes. In one embodiment, an area of a drainage hole is less than 50% of the area of cell base surface 15.

A seedling tray can comprise any of a variety of flexible, durable materials, such as, but not limited to, silicone, rubber, low density polyethylene, nylon, other plastics, and similarly flexible materials, and combinations thereof. In a specific embodiment, a seedling tray 10 is formed as a monolithic piece from silicone, a synthetic rubber-like material. Silicone can be an advantageous material because it is flexible, resistant to cracking, has a high tolerance for extreme temperatures, is non-toxic, and can meet various food safety requirements. In one embodiment, a seedling tray is made entirely of a food-grade silicone material. Particularly beneficial, especially for organic gardeners, is the ability to sanitize silicone objects via steam or hot water without any use of chemical cleaners. This is an attractive option for gardeners as non-sterilizable seedling trays can carry fungi and bacteria from one season to the next, causing cross-contamination of new crops. Silicone can be safely sterilized at temperatures between −65° F. and 600° F.

Conventional seedling trays with tapered cells are flexible to facilitate removal of the seedlings from the cells. This flexibility can make conventional seedling trays difficult to handle, particularly larger seedling trays. They are usually lifted from the bottom side, which can be awkward and can adversely affect seedlings. The embodiments of the subject invention incorporate one or more carrier tabs to advantageously utilize the flexibility of seedling trays. The carrier tab can be used to lift a seedling tray from the top side. The flexibility of the seedling tray allows the weight of the cells, particularly when filled, to fold inward and come together at their sides, so the cells form a stable arc. This allows the cells to support each other and provide for more stable transport.

What is claimed is:

1. A seedling tray, configured from a flexible material, comprising:
a plurality of cells comprising tapered side walls, wherein an upper edge has a larger diameter than a lower base surface;
an upper terminus between the upper edges of the cells that connects at least a portion of the upper edges of the cells to form a number of cell rows and cell columns, wherein the tapering of the side walls forms a taper angle between the connected cells;
a flood rim that extends around a periphery of the cells to enclose the upper edges; and
at least one carrier tab arranged along a center line of the upper terminus, such that, when the seedling tray is lifted by the at least one carrier tab, the flexibility and the taper angle between the cells allow the seedling tray to bend, bringing the lower base surfaces together to form a stable arc across the base surfaces of the plurality of cells.

2. The seedling tray according to claim 1, wherein at least the upper terminus is flexible.

3. The seedling tray according to claim 2, wherein the cell walls are flexible.

4. The seedling tray according to claim 3, comprising at least one of silicone, rubber, low density polyethylene, nylon, plastic, and combinations thereof.

5. The seedling tray according to claim 4, comprising a food-grade silicone.

6. The seedling tray according to claim 1, wherein the number of cells in a row is greater than the number of cells in a column.

7. The seedling tray according to claim 4, wherein the carrier tab comprises a flared base that extends along at least a portion of the center line of the upper terminus.

8. The seedling tray according to claim 1, wherein a carrier tab has a length that at least 10%, 15%, 20%, 25%, 30%, 35%, or 40% of a total row length or a length between any two of the listed values and a height that is between approximately 1″ and approximately 5″, between approximately 2″ and approximately 4″, and between approximately 2.5″ and approximately 3″.

9. The seedling tray according to claim 8, wherein the carrier tab has a height of between approximately 1″ and approximately 5″ above the center line of the upper terminus.

10. The seedling tray according to claim 1, wherein the taper angle between cells is 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24° and/or 25°.

11. A seedling tray, configured from a flexible material, comprising:
a plurality of cells comprising tapered side walls, wherein an upper edge has a larger diameter than a lower base surface, and the cells have a shared upper side wall portion that forms an upper terminus;
a flood rim that extends around a periphery of the cells to enclose the upper edges and upper terminus; and
at least one carrier tab arranged along a center spine of the upper terminus, such that, when the seedling tray is lifted by the at least one carrier tab, the flexibility and the taper angle between the cells allows the seedling tray to bend bringing the base surfaces together to form a stable arc across the base surfaces of the plurality of cells.

12. The seedling tray according to claim 11, wherein the plurality of cells forms a single row and the center spine is between two cells of the single row.

13. The seedling tray according to claim 11, wherein the cell walls are flexible.

14. The seedling tray according to claim 11, wherein the taper angle between cells is 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24° and/or 25°.

15. The seedling tray according to claim 11, comprising at least one of silicone, rubber, low density polyethylene, nylon, plastic, and combinations thereof.

16. The seedling tray according to claim 11, wherein the carrier tab comprises a flared base that extends along at least a portion of the center line of the upper terminus.

17. A method for transporting a seedling tray comprising:
obtaining a seedling tray, according to claim 1; and
lifting the seedling tray by the at least one carrier tab, whereby the seedling tray bends to bring the base surfaces of the cells together for support and so the base surfaces form a stable arc across a bottom side.

18. The method according to claim 17, further comprising:
placing the seedling tray on a surface, whereby the base surfaces separate and cells are supported on the surface.

19. A method for transporting a seedling tray comprising:
obtaining a seedling tray, according to claim 11; and
lifting the seedling tray by the at least one carrier tab, whereby the seedling tray bends to bring the base surfaces of the cells together for support and so the base surfaces form a stable arc across a bottom side.

20. The method according to claim 19, further comprising:
placing the seedling tray on a surface, whereby the base surfaces separate and cells are supported on the surface.
